(19) United States
(12) Patent Application Publication
(10) Pub. No.: US 2017/0146211 A1
(43) Pub. Date: May 25, 2017

(54) LIGHTING DEVICE

(71) Applicant: Chia-Hsiang Wu, Hsinchu (TW)

(72) Inventor: Chia-Hsiang Wu, Hsinchu (TW)

(21) Appl. No.: 15/275,488

(22) Filed: Sep. 26, 2016

(30) Foreign Application Priority Data
Nov. 19, 2015 (TW) 104138276
Jul. 12, 2016 (TW) 105121890

(51) Int. Cl. F21S 8/10

(52) U.S. Cl. CPC F21S 48/1341; F21S 48/328; F21S 48/115; F21S 48/1388; F21S 48/1705

(57) ABSTRACT

A lighting device includes a base, a heat-conducting element, a heat-conducting column and two light-emitting components. The base includes a first surface and a second surface opposite to each other. The heat-conducting element is disposed on the first surface of the base. One end of the heat-conducting column is disposed on the second surface of the base and connected to heat-conducting element, and the heat-conducting column includes a first edge. The light-emitting components are disposed on two adjacent surfaces of said heat-conducting column separated by said first edge. The light-emitting components include two substrates and two light-emitting units. The substrates are disposed on two opposite sides of said first edge of said heat-conducting column, and each of the substrates includes a sidewall adjacent to the first edge. The light-emitting units are disposed on the substrates, and an outer edge of the light-emitting unit is adjacent to the corresponding sidewall.

### FIELD OF THE INVENTION

The invention relates to a lighting device, and more particularly to a lighting device for vehicles.

### BACKGROUND OF THE INVENTION

In the design of headlights for vehicles, firstly, it should be considered that the front road must be lightened for the driver to distinguish road conditions clearly. Further, illumination safety still should be considered; that is to say, when a car approaches from the front, it will be necessary to prevent vehicle's high-beam light from dazzling the other party's driver, so that the danger caused by the driver overlooking the front road conditions can be avoided. Therefore, there are regulations for vehicle headlights illumination in all countries and regions, i.e. when no car approaches from the front, it is allowed to use a high-beam headlight with a broader illumination area. On the other hand, when a car approaches from the front, it is necessary to switch the headlight into a low-beam light.

Tungsten filament bulbs are often adopted for the high-beam and low-beam headlights in current vehicles. However, such tungsten filament bulb lamps have poor efficiency and are prone to damage caused by burn-out of the tungsten filament or breaking of the glass cover. Thus, lifetime and application of existing headlights are poor.

Currently, some light-emitting components are adopted to substitute tungsten filament bulbs, in order to improve the lifetimes of vehicle headlights. For example, it has become a common alternative scheme to use light-emitting diodes (LEDs) for replacing the conventional tungsten filament bulbs. However, structural limitations of conventional light-emitting diode would result in considerable differences in arrangement position of LED as compared to that of tungsten filament bulb. Meanwhile, the structure of conventional light-emitting diode would also limit its possible arrangement positions, instead of arranging at any desired position or the original arrangement position of the tungsten filament bulb. Thus, although the existing vehicle headlights have overcome the problems with tungsten filament bulb, such as short lifetime and breaking of glass cover due to burn-out prone filaments, the light-emitting components would departure from correct illumination position of the lighting device, resulting in occurrence of scattered light not conforming to the desired light profile during light-emission.

### SUMMARY OF THE INVENTION

The present invention provides a lighting device suitable for solving the problems in the prior art.

According to an embodiment of the invention, a lighting device includes a base, a heat-conducting element, a heat-conducting column and two light-emitting components. The base includes a first surface and a second surface opposite to each other. The heat-conducting element is disposed on the first surface of the base. One end of the heat-conducting column is disposed on the second surface of the base and connected to heat-conducting element, and the heat-conducting column includes a first edge. The light-emitting components are disposed on two adjacent surfaces of the heat-conducting column separated by the first edge. The light-emitting components include two substrates and two light-emitting units. The substrates are disposed on two opposite sides of the first edge of the heat-conducting column; each of the substrates includes a sidewall adjacent to the first edge. The light-emitting units are disposed on the substrates, and an outer edge of each of the light-emitting units is adjacent to the sidewall corresponding thereto.

According to an embodiment of the invention, the lighting device further comprises a lampshade connected to the base and including a reflective arc surface. The second surface of the base is disposed within the reflective arc surface, and the two light-emitting components are surrounded by the reflective arc surface.

According to an embodiment of the invention, the sidewalls are aligned with the first edge.

According to an embodiment of the invention, the outer edge of each of the said light-emitting units and the corresponding sidewall are spaced apart by a distance, and the distance is shorter than 1 mm.

According to an embodiment of the invention, a minimum linear distance between the two outer edges on top surfaces of the two light-emitting units is less than 4.5 mm.

According to an embodiment of the invention, the heat-conducting column is a triangular prism.

According to an embodiment of the invention, the heat-conducting column is a hollow column.

According to an embodiment of the invention, the two light-emitting components are disposed on an end of the heat-conducting column away from the base.

According to an embodiment of the invention, each of the light-emitting components is a light-emitting diode.

According to another embodiment of the invention, a lighting device includes a base, a heat-conducting element, a heat-conducting column, two light-emitting components and two reflective shields. The base includes a first surface and a second surface opposite to each other. The heat-conducting element is disposed on the first surface of the base. One end of the heat-conducting column is disposed on the second surface of the base and connected to the heat-conducting element, and the heat-conducting column includes a first edge. The light-emitting components are disposed on two adjacent surfaces of the heat-conducting column. The light-emitting components include two substrates and two groups of light-emitting units. The substrates are disposed on two opposite sides of the first edge of the heat-conducting column; each of the substrates includes a sidewall adjacent to the first edge. The groups of light-emitting units are disposed on the substrates, and an outer edge of each group of the light-emitting units is adjacent to the sidewall corresponding thereto. Each group of the light-emitting units includes first light-emitting units and second light-emitting units which are aligned with each other along the corresponding sidewall. The two reflective shields are disposed below the first light-emitting units, and each of the reflective shields includes a reflective surface adjacent to the first light-emitting units corresponding thereto.

According to another embodiment of the invention, the lighting device further includes a lampshade connected to the base and including a reflective arc surface. The second surface of the base is disposed within the reflective arc surface, and the two groups of light-emitting units are surrounded by the reflective arc surface.

According to another embodiment of the invention, the lampshade includes a light-emitting side, and the first light-emitting units are disposed closer to the light-emitting side than the second light-emitting units.

In sum, according to the embodiments of the present invention, the two light-emitting units of the two light-emitting components of the lighting device are disposed on the corresponding sidewalls of the substrate, so that the two light-emitting units are closely adjacent to each other for reducing the occurrence of scattered light and generating a preferable light-emitting profile when the light-emitting components are disposed on the heat-conducting column. Therefore, with the external lampshade, the two light-emitting units would be commonly disposed at positions within the lampshade standard to the arrangement of light source, so that a preferable illumination pattern of the lighting device is achieved and occurrence of scattered light is reduced simultaneously.

### BRIEF DESCRIPTION OF THE DRAWINGS

The invention will become more readily apparent to those ordinarily skilled in the art after reviewing the following detailed description and accompanying drawings, in which:

FIG. 1 depicts a side view of a lighting device according to an embodiment of the invention;

FIG. 2 depicts a front view of a lighting device of FIG. 1 without a shield;

FIG. 3 depicts a schematic diagram of the light-emitting components of a lighting device of FIG. 1;

FIG. 4 depicts a side view of a lighting device according to another embodiment of the invention;

FIG. 5 depicts a side view of a lighting device according to yet another embodiment of the invention;

FIG. 6 depicts a front view of a lighting device of FIG. 5 without the shield;

FIG. 7 depicts a front view of a lighting device according to still another embodiment of the invention;

FIG. 8 depicts a schematic diagram of the light-emitting components of a lighting device of FIG. 7;

FIG. 9 depicts a side view of a lighting device according to yet still another embodiment of the invention; and

FIG. 10 depicts a front view of a lighting device of FIG. 9.

### DETAILED DESCRIPTION OF PREFERRED EMBODIMENTS

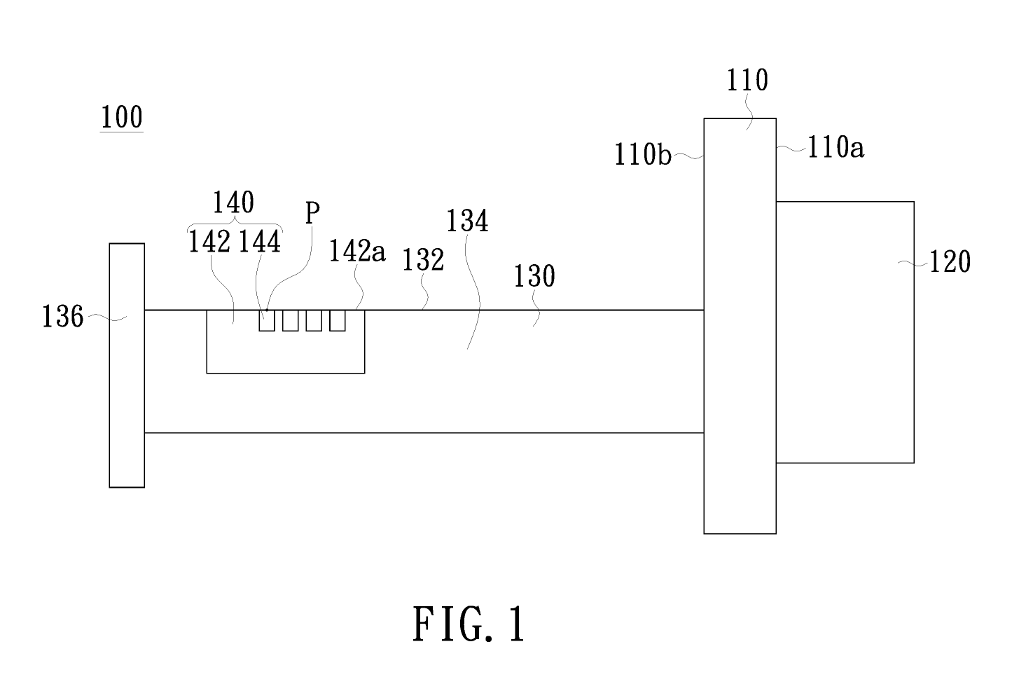

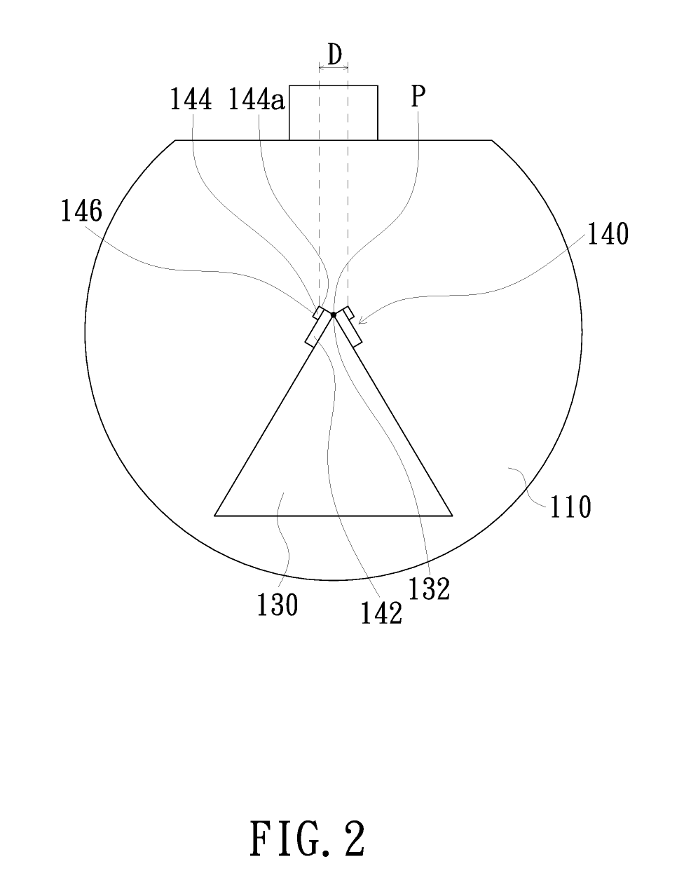

Referring to FIGS. 1 and 2. FIG. 1 depicts a side view of a lighting device according to an embodiment of the invention, and FIG. 2 depicts a front view of a lighting device of FIG. 1 without a shield. As shown in FIGS. 1 and 2, the present embodiment discloses a lighting device 100, including a base 110, a heat-conducting element 120, a heat-conducting column 130 and two light-emitting components 140. The lighting device 100 as disclosed in the present embodiment is applicable to a vehicle lamp. More particularly, the lighting device 100 as disclosed in the present embodiment is applicable to a vehicle headlamp.

The base 110 includes a first surface 110a and a second surface 110b opposite to each other. The heat-conducting element 120 is disposed on the first surface 110a of the base 110. For example, the first surface 110a of the base 110 is the surface away from the light-emitting components 140. The heat-conducting element 120 can be externally connected to a starting apparatus (not shown), for starting the light-emitting components 140 electrically connected thereto. That is, the light-emitting components 140 are connected to the starting apparatus (not shown) via wires passing through the base 110 and the heat-conducting element 120.

One end of the heat-conducting column 130 is disposed on a second surface 110b of the base 110, extends through the base 110 and connects to heat-conducting element 120. However, the present invention is limited thereto; the heat-conducting element 120 can also extends through the base 110 and connects to one end of the heat-conducting column 130. On the other hand, the heat-conducting column 130 may include a first edge 132. More specifically, the first edge 132 is an edge formed at the connection of the two neighboring surface 134 of the heat-conducting column 130. On the other hand, according to the present embodiment, the heat-conducting column 130 may be a triangular prism or a hollow column; but the present invention is not limited thereto. The heat-conducting column 130 is suitable for conducting heat at a heat source generated by the irradiation of the light-emitting components 140 arranged on the heat-conducting column 130, from the heat-conducting column 130 to the heat-conducting element 120. By heat exchange with the environment, a prolonged lifetime of the lighting device 100 may be achieved by improved heat-dissipation resulted from transmitting the heat source of the light-emitting components 140 into the environment. According to the present embodiment, the heat-conducting column 130 and the heat-conducting element 120 may be made of metals with high thermal conductivities; for example, the heat-conducting column 130 and the heat-conducting element 120 may be made of an aluminum material.

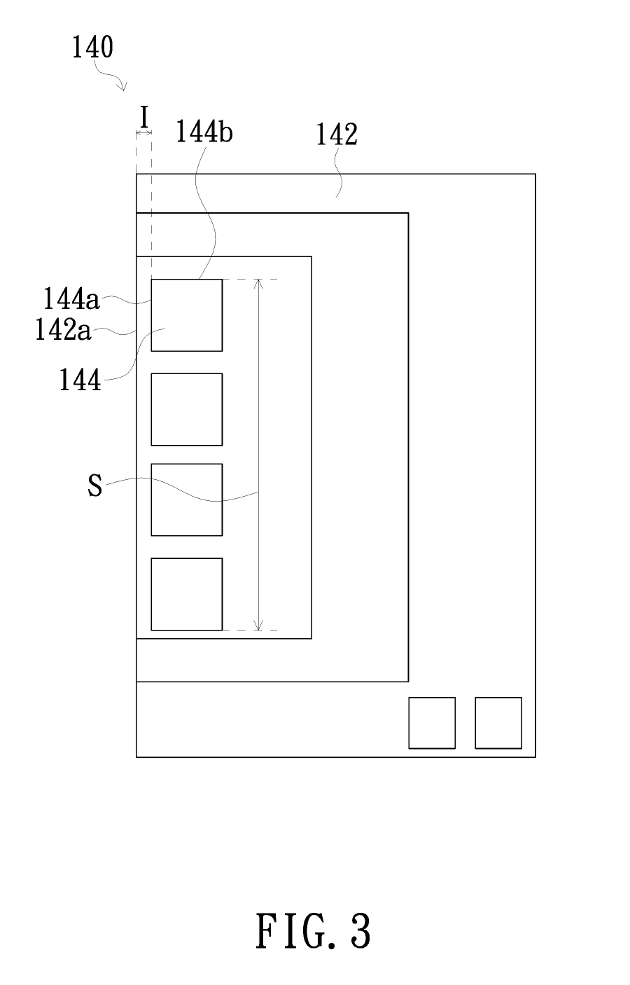

In detail, each of the light-emitting components 140 is disposed on one of the two adjacent surfaces 134 of the heat-conducting column 130 separated by the first edge 132. Also referring to FIG. 3. FIG. 3 depicts a schematic diagram of the light-emitting components of the lighting device shown in FIG. 1. As shown in FIGS. 1-3, the light-emitting components 140 include two substrates 142 and two light-emitting units 144. Each of the substrates 142 are disposed on one of two sides of the first edge 132 of the heat-conducting column 130, and each of the substrates 142 includes a sidewall 142a adjacent to the first edge 132.

Each of the light-emitting units 144 are disposed on one of the two substrates 142, and an outer edge 144a of each of the light-emitting units 144 is adjacent to the corresponding sidewall 142a. In detail, the light-emitting units 144 are composed of light-emitting chips and phosphor layers coated thereon. A first color light emitted by the light-emitting chips is mixed with a second color light excited by the phosphor layers to generate a target emission color, i.e. a third color light (such as a white light) emitted from the light-emitting units 144. Further, lifetimes of the light-emitting units 144 may be prolonged by coating a protective adhesive on the exterior of the light-emitting units 144. According to the present embodiment, a plurality of light-emitting units 144 are disposed on the light-emitting components 140, but the present invention is not limited thereto. The present embodiment is still functional when there is only one light-emitting unit 144 on the light-emitting components 140. For example, the amount of the light-emitting units 144 on the light-emitting components 140 may be 1-10, but the present invention is not limited thereto. In detail, according to the present embodiment, a minimum linear distance S between two opposite edges 144b of the light-emitting units 144 furthest away from each other, is 2-6 mm, and a length of each of the edges 144b is 0.2-1.5 mm; but the present invention is not limited thereto.

Further, according to this embodiment, the sidewalls 142a of the substrate 142 are commonly aligned with the first edge 132, so that the two sidewalls 142a form an angle of 2 to 100 degrees; however, the present invention is not limited thereto. On the other hand, the outer edge 144a of each of the light-emitting units 144 and the corresponding sidewall 142a are spaced apart by a distance; and the distance I may be, but is not limited to, less than 1 mm. In detail, when a plurality of the light-emitting units 144 are disposed on one of the surfaces 134 of the heat-conducting column 130, the light-emitting units 144 may, but is not limited to, be arranged at intervals along the corresponding sidewall 142a. According to the present embodiment, the two light-emitting components 140 are each disposed on an end of the heat-conducting column 130 away from the base 110, but the present invention is not limited thereto. According to another embodiment, the two light-emitting components 140 are disposed on any position of a front surface 134 of the heat-conducting column 130 away from the base 110. According to the present embodiment, a shield 136 is disposed on an end of the heat-conducting column 130 away from the base 110, and the light-emitting components 140 are disposed between the shield 136 and the base 110.

In addition, according to the present embodiment, a minimum linear distance D between two outer edges 144a of the top surface 146 of the two light-emitting units 144 is less than 4.5 mm, but the present invention is not limited thereto. According to the present embodiment, each of the light-emitting components 140 may be, but is not limited to, a light-emitting diode.

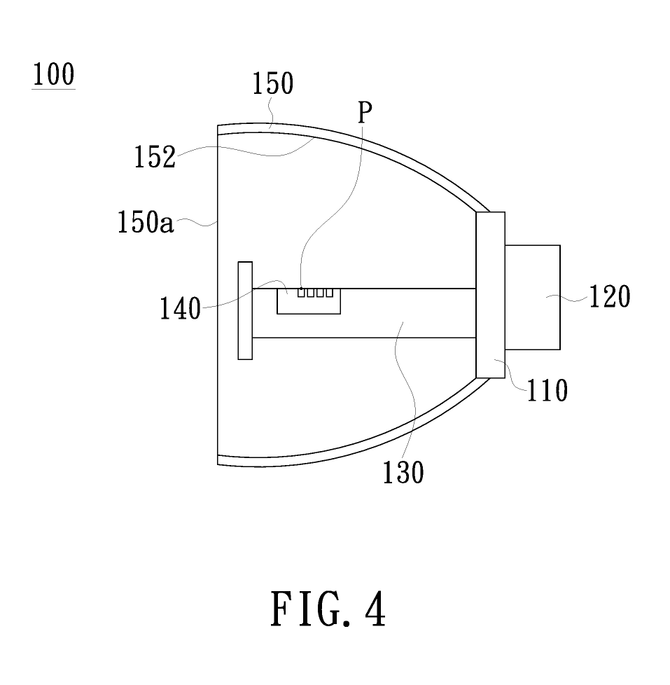

FIG. 4 depicts a side view of a lighting device according to another embodiment of the invention. According to the present embodiment, a lighting device 100 further includes a lampshade 150 connected to the base 110 and including a reflective arc surface 152. That is, the reflective arc surface 152 is of a spherical shape or a parabolic shape, but the present invention is not limited thereto. Further, a second surface 110b of the base 110 is disposed within the reflective arc surface 152 and the light-emitting components 140 are surrounded by the reflective arc surface 152, so that light beams emitted from the light-emitting components 140 are reflected by the reflective arc surface 152, focused into a concentrated light source and emitted from a light-emitting side 150a of the lampshade 150; however, the present invention is not limited thereto. In addition, the first edge 132 of the heat-conducting column 130 may pass through a light source arrangement point P of the lampshade 150 that conforms to the ECE or SAE standard. Further, the light-emitting components 140 are disposed at positions adjacent to the light source arrangement point P, and the light-emitting units 144 of the light-emitting components 140 neighbors with the first edge 132 as they are adjacent to the sidewall 142a of the substrate 142. Therefore, according to this embodiment, the light-emitting components 140 can be precisely disposed at the light source arrangement point P of the lampshade 150 that conforms to the ECE or SAE standard, so that overall light-emission efficiency is achieved and occurrence of scattered light is avoided.

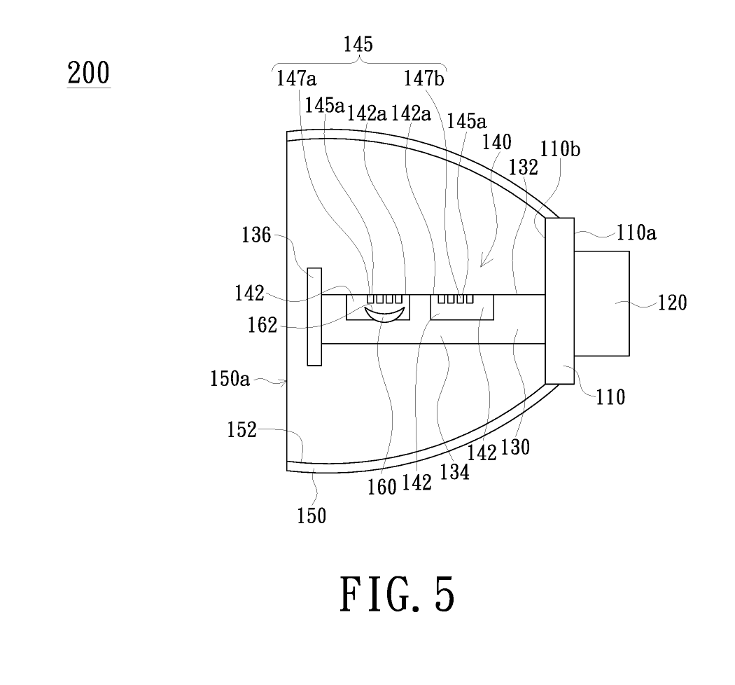

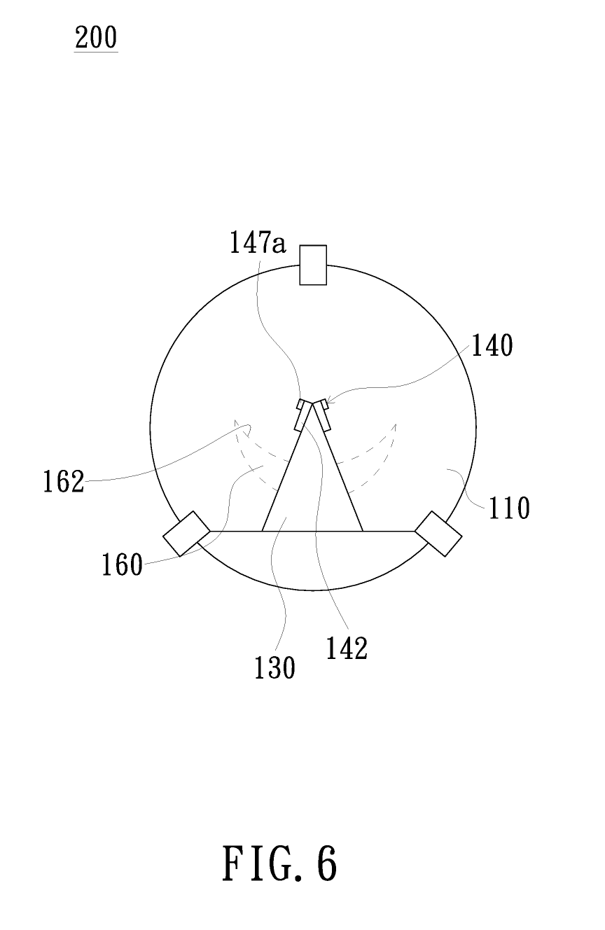

Referring to FIGS. 5 and 6. FIG. 5 depicts a side view of a lighting device according to yet another embodiment of the invention. FIG. 6 depicts a front view of a lighting device of FIG. 5 without the shield. It should be understood that a portion of structural features of the lighting device 200 of this embodiment are substantially similar to those of the lighting device 100 of the previous embodiment. Therefore, detailed descriptions for the same components between the two embodiments are omitted.

As shown in FIGS. 5 and 6, the lighting device 200 of the present embodiment includes a base 110, a heat-conducting element 120, a heat-conducting column 130, two light-emitting components 140 and two reflective shields 160. The base 110 includes a first surface 110a and a second surface 110b opposite to each other. The heat-conducting element 120 is disposed on the first surface 110a of the base 110. One end the heat-conducting column 130 is disposed on a second surface 110b of the base 110 and connected to a heat-conducting element 120, and the heat-conducting column 130 includes a first edge 132. The light-emitting components 140 include two substrates 142 and two groups of light-emitting units 145. The substrates 142 are disposed on two opposite sides of the first edge 132 of the heat-conducting column 130, and each of the substrates 142 includes a sidewall 142a adjacent to the first edge 132. The two groups of light-emitting units 145 are disposed on the two substrates 142, respectively; and an outer edge 145a of each group of light-emitting units 145 is adjacent to the corresponding sidewall 142a. Each group of light-emitting units 145 includes first light-emitting units 147a and second light-emitting units 147b aligned with each other along the corresponding sidewall 142a. The second light-emitting units 147b are disposed between the first light-emitting units 147a and the base 110. Each of the two reflective shields 160 are disposed below the first light-emitting units 147a, and includes a reflective surface 162 adjacent to the corresponding first light-emitting units 147a. Therefore, the first light-emitting units 147a and the reflective shields 160 together may constitute a low-beam module, and the second light-emitting units 147b may constitute a high-beam module. With an external switching device (not shown), illumination of the first light-emitting units 147a or the second light-emitting units 147b may be controlled so as to activate the low-beam module or the high-beam module for vehicle headlights. For example, an angle of light emission of the first light-emitting units 147a is 5 to 100 degrees, and an angle of light emission of the second light-emitting units 147b is 1 to 70 degrees; however, the present invention is not limited thereto. In addition, according to this embodiment, the first light-emitting units 147a and the second light-emitting units 147b are disposed in plurality on one of the surfaces 134 of the heat-conducting column 130; however, according to another embodiment, the present invention may be implemented by disposing only one first light-emitting unit 147a and only one second light-emitting unit 147b on one of the surfaces 134 of the heat-conducting column 130.

Further, according to this embodiment, the lighting device 200 further includes a lampshade 150 connected to the base 110 and including a reflective arc surface 152, That is, the reflective arc surface 152 is of a spherical shape or a parabolic shape; but the present invention is not limited thereto. Further, a second surface 110b of the base 110 is disposed within the reflective arc surface 152 and the light-emitting components 140 are surrounded by the reflective arc surface 152, so that light beams emitted from the light-emitting components 140 are reflected by the reflective arc surface 152, focused into a concentrated light source and emitted from a light-emitting side 150a of the lampshade 150; however, the present invention is not limited thereto. In addition, the first edge 132 of the heat-conducting column 130 may pass through a light source arrangement point P of the lampshade 150 that conforms to the ECE or SAE standard. Further, the light-emitting components 140 are disposed at positions adjacent to the light source arrangement point P, and the groups of light-emitting units 145 of the light-emitting components 140 neighbor with the first edge 132 as they are adjacent to the sidewall 142a of the substrate 142. Therefore, according to this embodiment, the light-emitting components 140 can be precisely disposed at the light source arrangement point P of the lampshade 150 that conforms to the ECE or SAE standard, so that overall light-emission efficiency is achieved and occurrence of scattered light is avoided. Further, the lampshade 150 includes the light-emitting side 150a, and the first light-emitting units 147a are closer to the light-emitting side 150a than the second light-emitting units 147b.

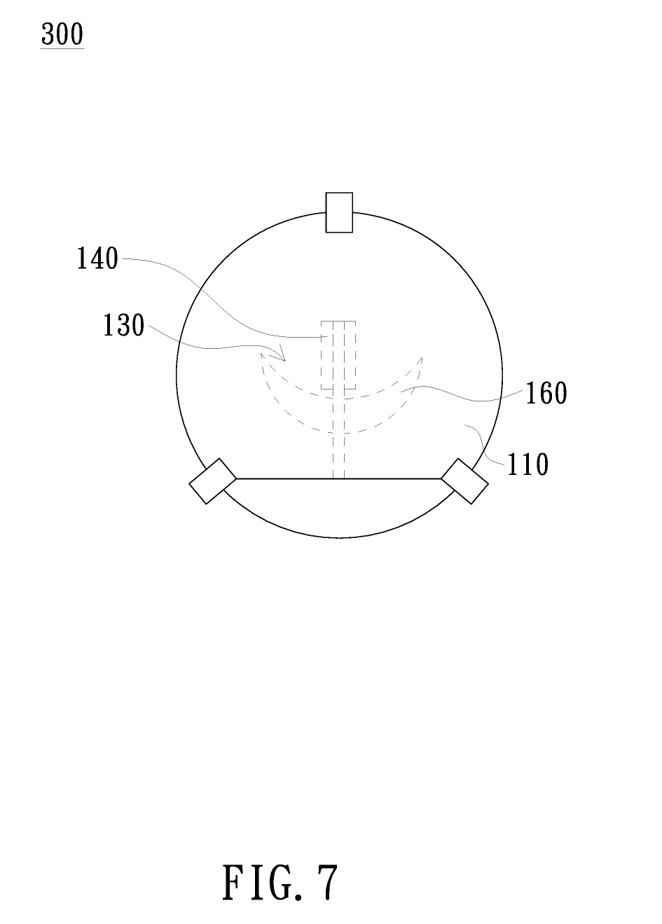

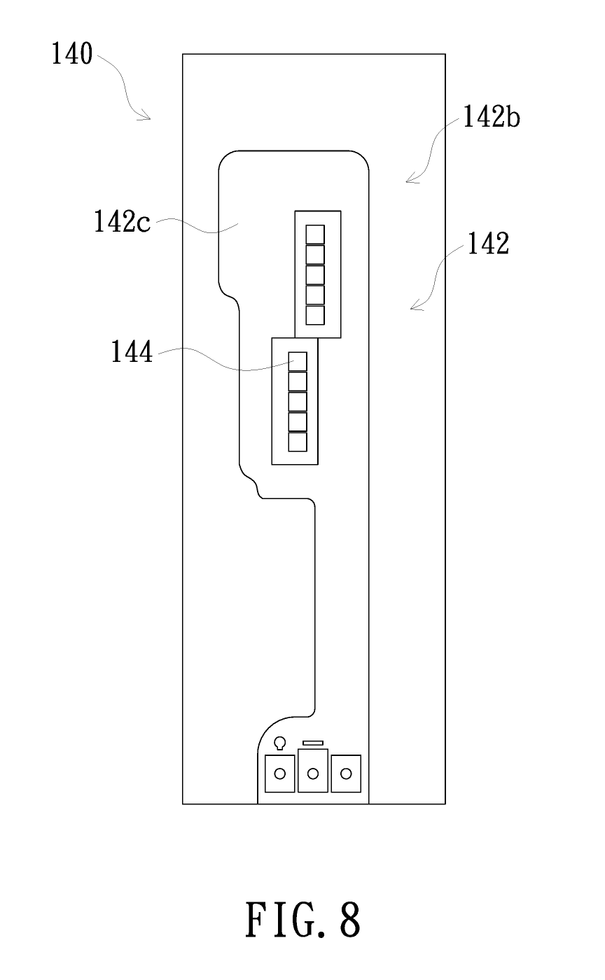

Referring to FIGS. 7 and 8. FIG. 7 depicts a front view of a lighting device according to still another embodiment of the invention. FIG. 8 depicts a schematic diagram of the light-emitting components of the lighting device as shown in FIG. 7. As shown in FIGS. 7 and 8, the main difference between the present embodiment and the previous embodiments is that the light-emitting component 140 of this embodiment is defined as a single light-emitting component disposed on the heat-conducting column 130. In detail, the light-emitting component 140 may be inserted into a cavity formed in the heat-conducting column 130. The light-emitting components 140 comprise a substrate 142 and two light-emitting units 144. The substrate 142 is provided on the heat-conducting column 130, in detail, the substrate 142 is inserted in a cavity which is formed in the heat-conducting column 130. The two light-emitting units 144 are disposed on two opposite sidewalls of the substrate 142, and protrude from the heat-conducting column 130. An outer edge of each of the light-emitting units 144 is adjacent to the corresponding sidewall of the substrate 142. In detail, the substrate 142 includes a circuit board 142b and two ceramic substrates 142c; the two ceramic substrates 142c are disposed on two opposite sidewalls of the circuit board 142b and between the circuit board 142b and the corresponding light-emitting units 144. It should be understood that the circuit board 142b may be a double-sided copper circuit board electrically connected to the light-emitting units 144 disposed on two opposite sides thereof.

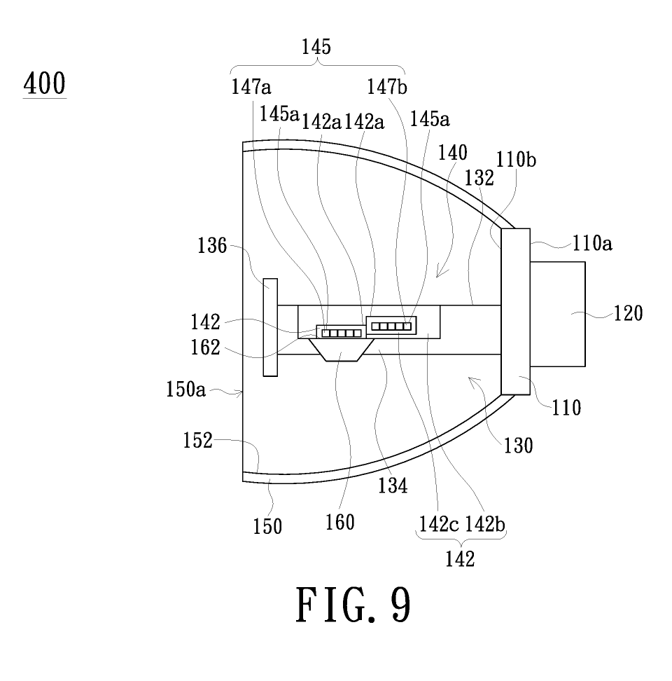

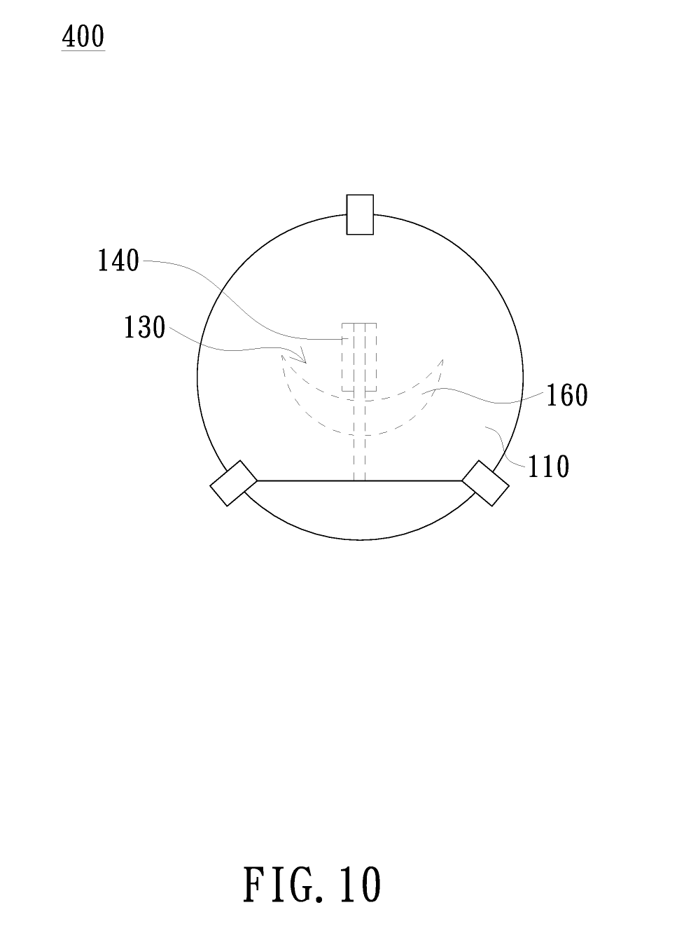

Further, referring to FIGS. 9 and 10. FIG. 9 depicts a side view of a lighting device according to yet still another embodiment of the invention. As shown in FIG. 9, according to this embodiment, a lighting device 400 is substantially similar to the lighting device 200 of the embodiment as shown in FIGS. 5 and 6 in their structures, and the main difference between the present embodiment and the previous embodiments is that the light-emitting component 140 of this embodiment is defined as a single light-emitting component disposed on the heat-conducting column 130. In detail, the light-emitting components 140 may be inserted into a cavity formed in the heat-conducting column 130. The light-emitting component 140 includes two substrates 142 and two groups of light-emitting units 145. The substrates 142 are disposed on the heat-conducting column 130, and are inserted into a cavity formed in the heat-conducting column 130. The two groups of light-emitting units 145 are disposed on two opposite sidewalls of the substrates 142, and protrude from the heat-conducting column 130. An outer edge of each group of the light-emitting units 145 is adjacent to a sidewall of the corresponding substrate 142, and each group of the light-emitting units 145 includes first light-emitting units 147a and second light-emitting units 147b aligned with each other along the corresponding sidewall. In detail, the substrates 142 includes a circuit board 142b and two ceramic substrates 142c; the two ceramic substrates 142c are disposed on two opposite sidewalls of the circuit board 142b and between the circuit board 142b and the corresponding groups of light-emitting units 145. It should be understood that the circuit board 142b may be a double-sided copper circuit board electrically connected to the groups of light-emitting units 145 disposed on two opposite sides thereof.

In sum, by utilizing the above-described embodiments of the present invention, it should be appreciated that advantages of the present invention include the followings. According to the embodiments of the present invention, the two light-emitting units of the two light-emitting components of the lighting device are disposed on the corresponding sidewall of the substrate, so that the two light-emitting units are closely adjacent to each other for reducing the occurrence of scattered light and generating a preferable light-emitting profile when the light-emitting components are disposed on the heat-conducting column. Therefore, with the external lampshade, the two light-emitting units would be commonly disposed at positions within the lampshade that conforms to the standards of arrangement of light sources, so that a preferable illumination pattern of the lighting device is achieved and occurrence of scattered light is reduced simultaneously.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A lighting device, comprising:
a base, comprising a first surface and a second surface opposite to each other;
a heat-conducting element, disposed on said first surface of said base;
a heat-conducting column, one end thereof being disposed on said second surface of said base and connected to said heat-conducting element, said heat-conducting column comprising a first edge; and
two light-emitting components, each disposed on one of two adjacent surfaces of said heat-conducting column separated by said first edge, wherein said light-emitting components comprises:
two substrates, each disposed on one of two opposite sides of said first edge of said heat-conducting column, each of said substrates comprising a sidewall adjacent to said first edge; and
two light-emitting units, each disposed on one of said two substrates, an outer edge of each of said light-emitting units being adjacent to said sidewall corresponding thereto.

2. The lighting device according to claim 1, further comprising:
a lampshade, connected to said base and comprising a reflective arc surface, wherein said second surface of said base is disposed within said reflective arc surface, and said two light-emitting components are surrounded by said reflective arc surface.

3. The lighting device according to claim 1, wherein said two sidewalls are aligned with said first edge.

4. The lighting device according to claim 1, wherein said outer edge of each of said light-emitting units and said corresponding sidewall are spaced apart by a distance, and said distance is shorter than 1 mm.

5. The lighting device according to claim 1, wherein a minimum linear distance between said two outer edges on top surfaces of said two light-emitting units is less than 4.5 mm.

6. The lighting device according to claim 1, wherein said heat-conducting column is a triangular prism.

7. The lighting device according to claim 1, wherein said heat-conducting column is a hollow column.

8. The lighting device according to claim 1, wherein said two light-emitting components are disposed on an end of said heat-conducting column away from said base.

9. The lighting device according to claim 1, wherein each of said light-emitting components is a light-emitting diode.

10. A lighting device, comprising:
a base, comprising a first surface and a second surface opposite to each other;
a heat-conducting element, disposed on said first surface of said base;
a heat-conducting column, one end thereof being disposed on said second surface of said base and connected to said heat-conducting element, said heat-conducting column comprising a first edge;
two light-emitting components, each disposed on one of two adjacent surfaces of said heat-conducting column, wherein said light-emitting components comprise:
two substrates, each disposed on one of two opposite sides of said first edge of said heat-conducting column, each of said substrates comprising a sidewall adjacent to said first edge; and
two groups of light-emitting units, each disposed on one of said two substrates, an outer edge of each of said two groups of light-emitting units being adjacent to said sidewall corresponding thereto, wherein each of said two groups of light-emitting units comprises first light-emitting units and second light-emitting units aligned with each other along said corresponding sidewall; and
two reflective shields, each disposed below said first light-emitting units, each of said reflective shields comprising a reflective surface adjacent to said first light-emitting units corresponding thereto.

11. The lighting device according to claim 10, further comprising:
a lampshade, connected to said base and comprising a reflective arc surface, wherein said second surface of said base is disposed within said reflective arc surface, and said two groups of light-emitting units are surrounded by said reflective arc surface.

12. The lighting device according to claim 11, wherein said lampshade comprises a light-emitting side, and said first light-emitting units are disposed closer to said light-emitting side than said second light-emitting units.

13. A lighting device, comprising:
a base, comprising a first surface and a second surface opposite to each other;
a heat-conducting element, disposed said first surface of said base;
a heat-conducting column, one end thereof being disposed on said second surface of said base and connected to said heat-conducting element; and
a light-emitting component, disposed on said heat-conducting column, wherein said light-emitting component comprises:
a substrate, disposed on said heat-conducting column; and
two light-emitting units, each disposed on one of two opposite sidewalls of said substrate and protruding from said heat-conducting column, an outer edge of each of said light-emitting units being adjacent to said sidewall corresponding thereto.

14. The lighting device according to claim 13, wherein said substrate comprises a circuit board and two ceramic substrates, said two ceramic substrates are disposed on two opposite sidewalls of said circuit board, and each of the two ceramic substrates is disposed between and electrically connected to said circuit board and one of said two light-emitting units corresponding thereto.

15. A lighting device, comprising:
a base, comprising a first surface and a second surface opposite to each other;
a heat-conducting element, disposed on said first surface of said base;
a heat-conducting column, one end thereof being disposed on said second surface of said base and connected to said heat-conducting element, said heat-conducting column comprising a first edge;
a light-emitting component, disposed on said heat-conducting column, wherein said light-emitting component comprises:
a substrate, disposed on said heat-conducting column; and
two groups of light-emitting units, each disposed on one of two opposite sidewalls of said substrate and protruding from said heat-conducting column, wherein each of the two groups of light-emitting units comprises first light-emitting units and second light-emitting units aligned with each other along said corresponding sidewall; and
two reflective shields, each disposed below said first light-emitting units, each of said reflective shields comprising a reflective surface adjacent to said first light-emitting units corresponding thereto.

16. The lighting device according to claim 15, wherein said substrate comprises a circuit board and two ceramic substrates, said two ceramic substrates are disposed on two opposite sidewalls of said circuit board, and each of the two ceramic substrates is disposed between and electrically connected to said circuit board and one of said two groups of light-emitting units corresponding thereto.
